(19) United States
(12) Patent Application Publication
(10) Pub. No.: US 2009/0267985 A1
(43) Pub. Date: Oct. 29, 2009

(54) LIQUID EJECTING APPARATUS

(75) Inventor: Toshiki USUI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/429,489

(22) Filed: Apr. 24, 2009

(30) Foreign Application Priority Data
Apr. 25, 2008 (JP) 2008-116108

(51) Int. Cl. B41J 29/377

(52) U.S. Cl. 347/18

(57) ABSTRACT

There is provided a liquid ejecting apparatus including a head for ejecting liquid on a medium, a moving mechanism for moving the head in a predetermined direction, and a fan. The fan flows air in the liquid ejecting apparatus in the predetermined direction.

### BACKGROUND

1. Technical Field

The present invention relates to a liquid ejecting apparatus.

2. Related Art

As a liquid ejecting apparatus, an ink jet printer in which a driving element is driven by a driving signal and ink is eject from a nozzle has been known. When printing is performed for a long period, a driving signal generating unit for generating the driving signal is excessively heated to cause a failure of the printer.

Consequently, a method has been proposed in which a cooling fan is provided in the printer to generate an airstream in the printer, and the driving signal generating unit is cooled by the airstream to avoid failure of the printer (for example, see JP-2003-285435).

Incidentally, in the ink jet printer, there is a problem in that ink mist (micro ink drop) floating in the printer is adhered on a head peripheral member to talent a medium.

### SUMMARY

According to an aspect of the invention, there is provided a liquid ejecting apparatus including a head for ejecting liquid on a medium, a moving mechanism for moving the head in a predetermined direction, and a fan. The fan flows air in the liquid ejecting apparatus in the predetermined direction.

With the liquid ejecting apparatus, a micro liquid drop floating over a moving range of the head can be moved to a non liquid ejection area, and it can be prevented that a micro liquid drop is adhered on a head peripheral member. As a result, taint of a medium can be prevented.

It is preferable that a position of the head is detected based on a linear scale attached along the predetermined direction in the liquid ejecting apparatus according to the aspect of the invention.

With the liquid ejecting apparatus, it can be prevented that a micro liquid drop is adhered on the linear scale, and the position of the head can be detected with high accuracy.

It is preferable that the head is positioned between a position at which air is flowed in the predetermined direction by the fan and the linear scale in the liquid ejecting apparatus according to the aspect of the invention.

With the liquid ejecting apparatus, a micro liquid drop can be kept away from the linear scale as far as possible with the air flowing in the predetermined direction, and it can be prevented that a micro liquid drop is adhered on the linear scale.

It is preferable that the liquid ejecting apparatus according to the aspect of the invention further includes a driving signal generating unit for generating a driving signal, and the head ejects liquid depending on the driving signal and the fan is provided for cooling the driving signal generating unit.

With the liquid ejecting apparatus, failure of the liquid ejecting apparatus cause by excessive heat generation of the driving signal generating unit can be prevented. Lowering the cost and space saving can be provided by using the fan for preventing adherence of a micro liquid drop on a head peripheral member also as a fan for cooling the drive signal generating unit.

It is preferable that air is sent in the predetermined direction by the air sent from the fan in the liquid ejecting apparatus according to the aspect of the invention.

With the liquid ejecting apparatus, it becomes easy to flow air in the liquid ejecting apparatus in the predetermined direction by sending the air from the fan, and a micro liquid drop can be easily moved to the non liquid ejection area.

It is preferable that the fan flows air at a position deviated in a direction perpendicular to the predetermined direction with respect to the head in the liquid ejecting apparatus according to the aspect of the invention.

With the liquid ejecting apparatus, it can be prevented that the air flowing in the predetermined direction hits the head to disturb the airstream. Further, when the fan for preventing adherence of a micro liquid drop on a head peripheral member is used also as a fan for cooling the driving signal generating unit and the fan suctions air from the exterior of the liquid ejecting apparatus, it can be prevented that the air heated by the driving signal generating unit that generates heat is blown to the head and the head is excessively heated to cause an ejection error.

It is preferable that the fan flows air above a liquid ejection surface of the head in the liquid ejecting apparatus according to the aspect of the invention.

With the liquid ejecting apparatus, t can be prevented that liquid adhered on a member (for example, platen and the like) positioned below the head is flown up. Further, it can be prevented that a liquid drop ejected from the liquid ejection surface of the head is landed at a position deviated from a normal position by receiving the influence of the airstream.

Other features of the invention will be apparent from the description of this specification and accompanying drawings.

### BRIEF DESCRIPTION OF THE DRAWINGS

The invention will be described with reference to the accompanying drawings, wherein like numbers reference like elements.

FIG. 1 is a block diagram showing an entire structure of a printer of an embodiment.

FIG. 2A is a perspective view of the printer, and FIG. 2B is a cross sectional view of the printer.

FIG. 3 is a diagram showing a driving signal generating circuit.

FIG. 4 is a diagram showing the driving signal generating circuit and a head driving circuit.

FIG. 5 is a timing chart of each signal.

FIG. 6A is a cross sectional view schematically showing the printer, and FIG. 6B is a top view schematically showing the printer.

FIG. 7 is a diagram showing a heat sink on a substrate of the driving signal generating circuit.

FIG. 8 is a perspective view of a printer.

FIG. 9A is a cross sectional view schematically showing the printer, and FIG. 9B is a top view schematically showing the printer.

### DESCRIPTION OF EXEMPLARY EMBODIMENTS

### Structure of Ink Jet Printer

Hereinafter, an embodiment will be described by using a serial type printer (printer 1) among an ink jet printer as a liquid ejecting apparatus

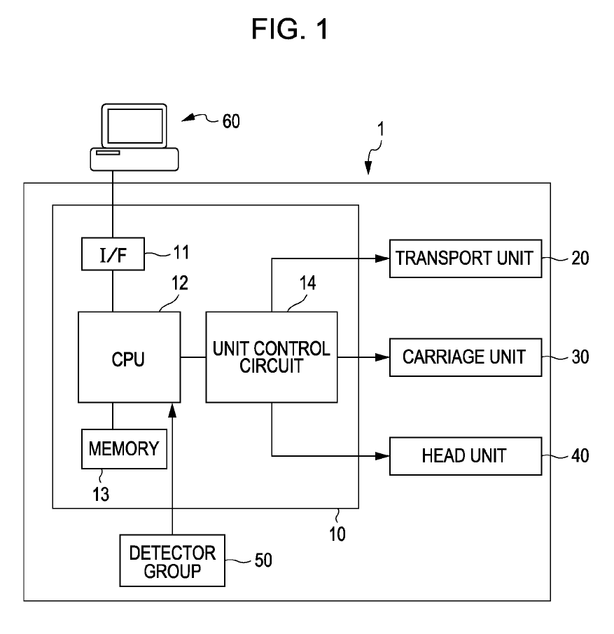

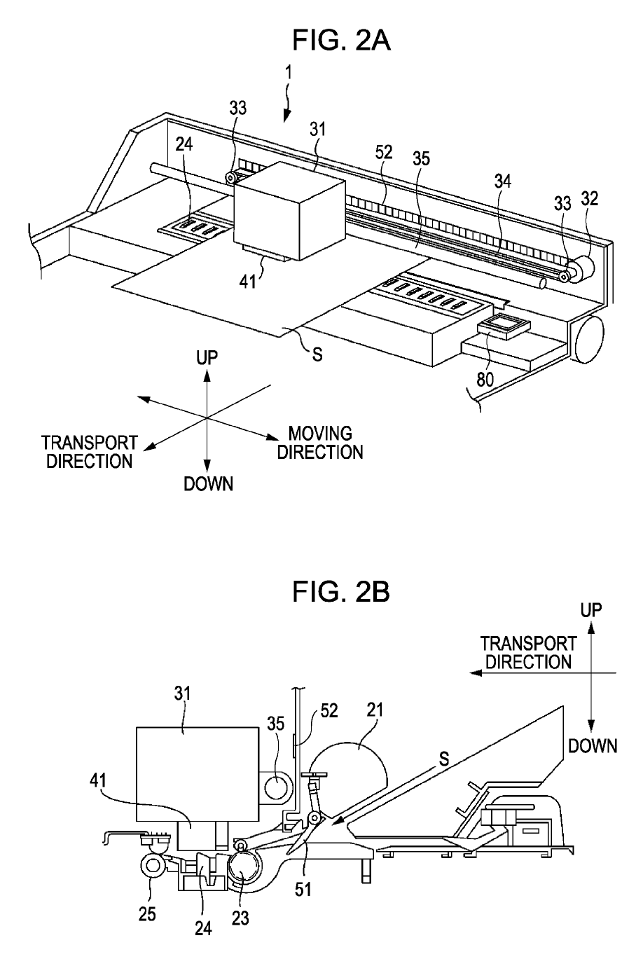

FIG. 1 is a block diagram showing an entire structure of the printer 1 of the embodiment. FIG. 2A is a perspective view showing a part of the printer 1, and FIG. 2B is a cross sectional view showing a part of the printer 1. The printer 1 that receives print data from a computer 60 that is an external device controls each unit (transport unit 20, carriage unit 30, head unit 40) by a controller 10 to form an image on a paper S (medium). Further, a detector group 50 monitors a state in the printer 1, and the controller 10 controls each unit based on the detected result.

The controller 10 is a control unit for controlling the printer 1. An interface unit 11 performs transmitting and receiving of data between the computer 60 that is an external device and the printer 1. A CPU 12 is an arithmetic processing unit for controlling the entire of the printer 1. A memory 13 is provided for ensuring an area for storing a program of the CPU 12, an operation area, and the like. The CPU 12 controls each unit 12 by a unit control circuit 14.

The transport unit 20 transports the paper S in a transport direction by a predetermined transport amount when printing is performed after the paper S is sent to a position at which printing can be performed. The transport unit 20 is equipped with a paper feed roller 21, a transport motor, a transport roller 23, a platen 24, and a paper discharge roller 25. The paper feed roller 21 is rotated to feed the paper S which should be printed to the transport roller 23. When a paper detecting sensor 51 detects a position of a distal end of the paper S sent from the paper feed roller 21, the controller 10 rotates the transport roller 23 to position the paper S at a print start position. When the paper S is positioned at the print start position, at least a part of nozzles of a head 41 opposes the paper S.

The carriage unit 30 (corresponding to moving mechanism) moves the head 41 in a moving direction (corresponding to predetermined direction) perpendicular to the transport direction. A timing belt 34 is wound around a pair of pullies 33, and a part of the timing belt is connected to a carriage. By rotation of the pully 33 attached at a rotation shaft of a carriage motor 32, the timing belt 34 is moved, and the carriage 31 and the head 41 are moved in the moving direction along a guide axis 35. The position of the carriage 31 (41) in the moving direction can be controlled by a linear type encoder provided at a back surface side of the carriage 31 that reads a linear scale 52.

The head unit 40 ejects ink on the paper S, and includes the head 41 (one head) and a head driving circuit 42 for driving the head 41. A plurality of nozzles which are an ink ejection unit is provided on a lower surface of the head 41. An ink chamber (not shown) in which ink is filled, and a driving element (piezo element) for ejecting ink by changing the capacity of the ink chamber are provided in each nozzle.

The printer 1 of a serial type intermittently ejects ink from the head 41 moving along the moving direction and repeats a dot forming processing for forming a dot on the paper S and a transport processing for transporting the paper S in the transport direction to form a dot at a position different from a dot formed by a foregoing dot forming processing for complete an image.

### Driving of Head

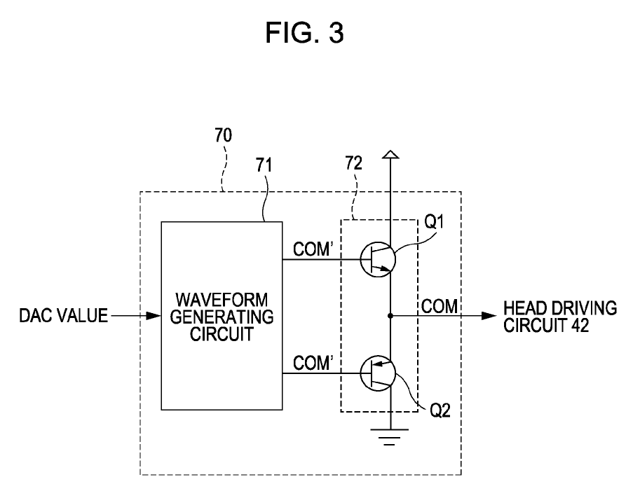

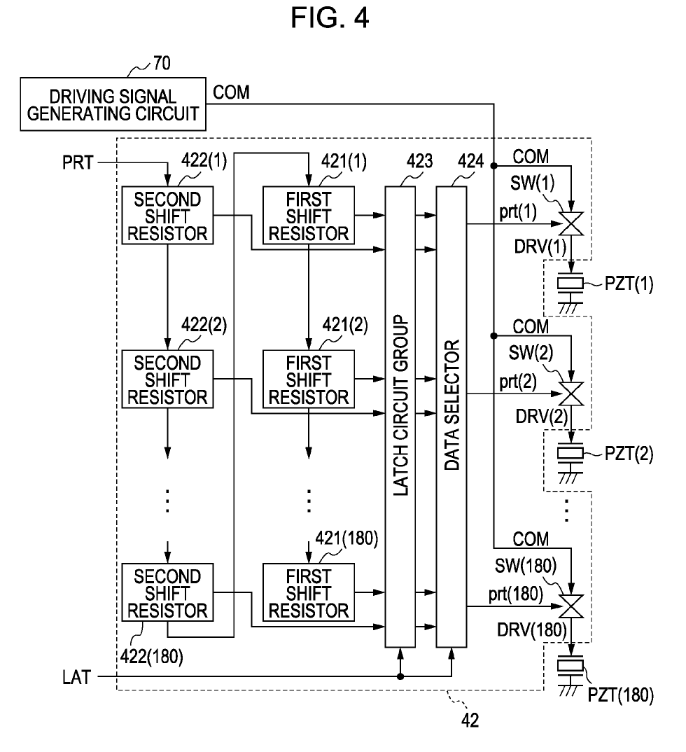

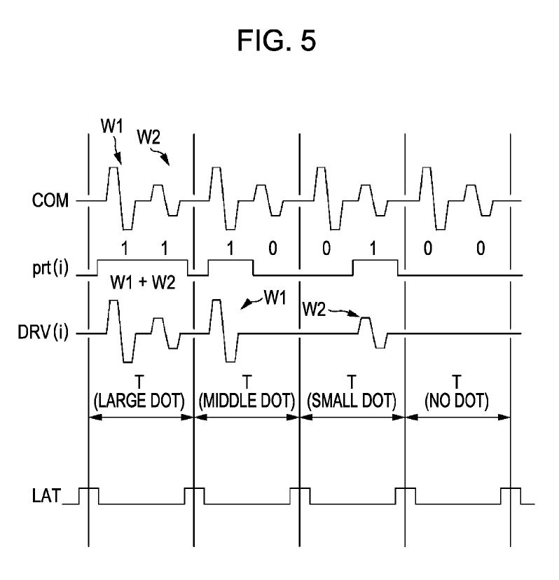

FIG. 3 is a diagram showing a driving signal generating circuit 70. FIG. 4 is a diagram showing the driving signal generating circuit 70 and a head driving circuit 42, and showing that a piezo element corresponding to each nozzle is operated by the head driving circuit 42. FIG. 5 is a timing chart of each signal.

### Driving Signal Generating Circuit

As shown in FIG. 3, the driving signal generating circuit 70 includes a waveform generating circuit 71 and a current amplifier circuit 72, and generates a driving signal COM commonly used to a nozzle group (piezoelectric element PZT) First, the waveform generating circuit 71 generates a voltage waveform signal COM′ (waveform information of analog signal) that becomes a base of the driving signal COM based on a DAC value (waveform information of digital signal). Then, the current amplifier circuit 72 amplifies the current of the voltage waveform signal COM′ and outputs the amplified voltage waveform signal COM′ as the driving signal COM.

The current amplifier circuit 72 includes an increase transistor Q1 (NPN type transistor) that is operated when the voltage of the driving signal COM is increased and a decrease transistor Q2 (PNP transistor) threat is operated when the voltage of the driving signal COM is decreased. The collector of the increase transistor Q1 is connected to a power source, and the emitter of the increase transistor Q1 is connected to an output signal line for the driving signal COM. The collector of the decrease transistor Q2 is connected to ground (earth) and the emitter of the decrease transistor Q2 is connected to the output signal line for the driving signal COM.

When the increase transistor Q1 becomes ON state by the voltage waveform signal COM′ transmitted from the waveform generating circuit 71, the driving signal COM is increased, and the piezo element PZT is charged. On the other hand, when the decrease transistor Q2 becomes ON state by the voltage waveform signal COM′, the driving signal COM is decreased and the piezo element PZT is discharged. Then, the driving signal COM having a first driving pulse W1 and a second driving pulse W2 is repeatedly generated in every cycle T as shown in FIG. 5.

### Head Driving Circuit

The head driving circuit 42 includes 180 first shift resistors 421, 180 second shift resistors 422, a latch circuit group 423, a data selector 424, and 180 switches SW. The head driving circuit 42 corresponds to a nozzle group formed by 180 nozzles, and a figure in parenthesis in FIG. 4 shows a number of a nozzle corresponding to a member (or signal).

First, a print signal PRT is input in the 180 first shift registers 421, and then, input in the 180 second shift resistors. As a result, the print signal PRT transmitted in serial is converted into a print signal PRT(i) which is 180 two bit data. The print signal PRT(i) is a signal corresponding to data for one pixel assigned to nozzle #i.

Then, when a rising pulse of a latch signal LAT is input in the latch circuit group 423, 360 data of each shift register is latched by the latch circuit group 423. When the rising pulse of the latch signal LAT is input in the latch circuit group 423, the rising pulse of the latch signal LAT is also input in the data selector 424, and the data selector 424 becomes an initial state.

Further, the data selector 424 selects a two bit print signal PRT(i) corresponding to each nozzle #i from the latch circuit group 423 before latched (before initial state), and outputs a switch control signal prt(i) corresponding to each print signal PRT(i) to each switch SW(i).

On/off control of the switch SW(i) corresponding to a piezo element PZT(i) is performed by the switch control signal prt(i). Then, by the on/off operation of the switch, the driving signal COM transmitted from the driving signal generating circuit 70 is applied or blocked with respect to the piezo element (DRV(i)), and ink is ejected from the nozzle #i, or not ejected.

### Ejection of Ink

For example, when the level of the switch control signal prt(i) is “1”, the switch SW(i) is turned on, and driving pulses (W1, W2) included in the driving signal COM are passed without change and the driving pulses are applied to the piezo element PZT(i). Then, when the driving pulses are applied to the piezo element PZT(i), the piezo element PZT(i) is deformed in accordance with the driving pulses, an elastic film (side wall) partitioning a part of an ink chamber is deformed, and ink in the ink chamber is ejected from the nozzle #i by a predetermined amount. On the other hand, when the level of the switch control signal prt(i) is “0”, the switch SW(i) is turned off, and the driving pulses included in the driving signal COM are blocked.

In the embodiment, the print signal prt(i) corresponding to one pixel is two bit data, and one pixel is expressed by four gradations of “large dot is formed”, “middle dot is formed”, “small dot is formed”, “no dot is formed”. As shown in FIG. 5, when the switch control signal prt(i) is “11”, the first driving pulse W1 and the second driving pulse W2 are applied to the piezo element PZT(i). Then, when the two driving pulses are applied to the piezo element PZT (i), ink is ejected from the nozzle #i by an ink amount corresponding to the large dot and a large dot is formed. Similarly, when the switch control signal prt(i) is “10”, a middle dot is formed, and when the switch control signal prt(i) is “01”, a small dot is formed. Further, when the switch control signal prt(i) is “00”, no driving signal is applied to the piezo element PZT(i), so that the piezo element PZT(i) is not deformed, and no dot is formed. That is, liquid is ejected from a nozzle of the head 41 depending on the driving signal.

### First Embodiment: Prevention of Adherence of Ink Mist

When a fine ink drop (hereinafter, referred to as ink mist) ejected from the nozzle is not landed on a paper and is flown up, or when ink adhered on a peripheral member of the head 41 such as the platen 24 is flown up, ink mist is floated in the printer 1. Particularly, many ink mist is floated in an area around the head 41, that is, in an area of a range in which the head 41 is moved by the carriage 31. When ink mist is adhered on a peripheral member of the head 41 (for example the platen 24 or the paper feed member), a medium may be tainted. Consequently, it is an object of the embodiment to reduce adherence of ink mist on a periphery member of the head 41.

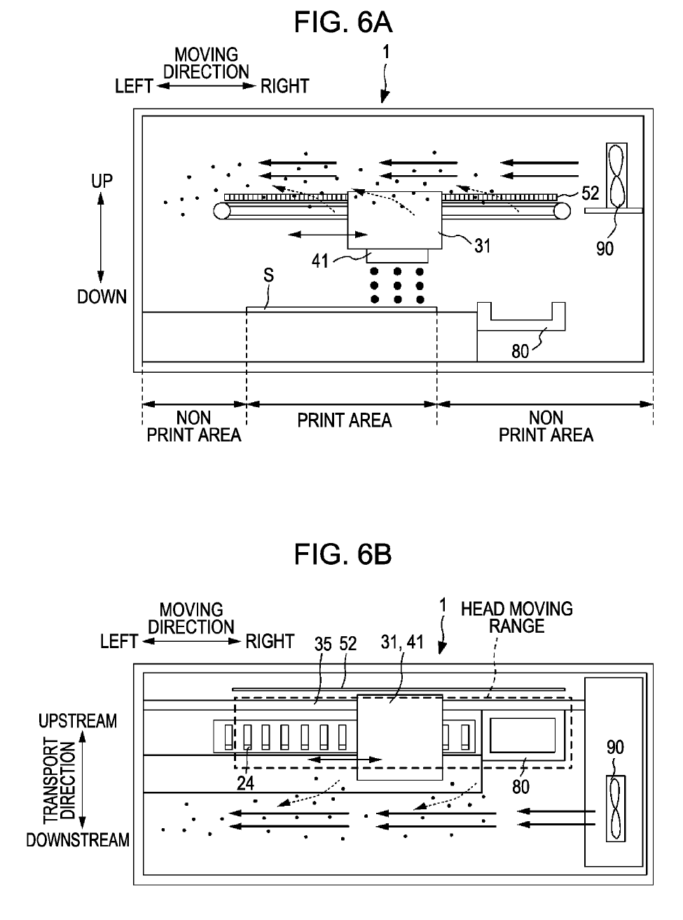

FIG. 6A is a cross sectional view schematically showing the printer 1 of the first embodiment, and FIG. 6B is a top view schematically showing the printer of the first embodiment. The printer 1 of the first embodiment includes a fan 90 that flows air in the moving direction (corresponding to predetermined direction) of the head 41. The fan 90 in FIGS. 6A and 6B is positioned in a non print area at the right side of the moving direction, and flows air from the right side to the left side in the moving direction. Note that as shown in FIG. 6A, an area in which ink is ejected on the paper S from the head 41 shall be “print area”, and an area except the print area shall be “non print area”. Further, in FIG. 6B, a moving range of the head 41 is shown by a dotted line. The head 41 moves not only in the print area, but also to a flashing unit 80 positioned in the non print area. Note that flushing is performed when the head 41 is moved to the flashing unit 80. The flashing is a processing for restoring the nozzle (cleaning processing) in order to prevent that a proper amount of ink is not ejected due to clogging of the nozzle cased by increase of ink viscosity near the nozzle or due to mixing of bubbles in the nozzle. In the cleaning operations a driving signal having no relation with the image to be printed is applied to the driving element to forcibly eject ink.

As shown in FIG. 6A, by flowing air in the moving direction by the fan 90 by using a space in which head 41 moves, the air from the fan 90 is flowed while attracting the ink mist floating over the moving range of the head 41, and the ink mist can be moved in the non print area. At this time, air from the fan 90 is flowed in the moving direction in the space in which ink mist is floated over the moving range of the head 41. Further, the ink mist floated in a pathway of the air flowed from the fan 90 moves to the non print area with the air. Further, even for the ink mist not floated in the pathway of the air, since the area in which air flows becomes a negative pressure area, the ink mist floating around the pathway of the air is also attracted by the airstream as shown by the arrows of dotted lines of FIGS. 6A and 6B. That is, by using the space in which the head 41 moves, by flowing air in the moving direction around the head 41, the ink mist floating in the moving range of the head 41 can be moved to the non print area. By moving the ink mist to the non print area, it can be prevented that ink mist is adhered on a member around the head 41 Specifically, by moving ink mist to the non print area, it can be prevented that ink mist is adhered on a member positioned in the print area and a medium is tainted.

As in the printer 1 of the embodiment, in the serial type printer by which an image is formed while moving the head 41 in the moving direction, a space for moving the head 41 is provided. Consequently, by flowing air by using the moving space of the head 41 in the moving direction by the fan 90, it becomes difficult that the airstream is disturbed, and ink mist can be moved to the non print area. Further, it can be prevented that the ink adhered on the platen 24 and the like is flown up by the disturbance of the airstream.

Note that, since the airstream from the fan 90 becomes week in the non print area at the left side of the moving direction, the ink mist moved in the non print area is appropriately discharged from any of openings that communicate the printer 1 and an exterior portion, or is adhered on a member positioned in the non print area, it can be prevented that the medium is tainted. When the ink mist is discharged from any of the openings that communicate the printer 1 and the exterior portion, it can be prevented that the exterior portion of the printer 1 is locally tainted.

Further, an exhaust opening (not shown) for air from the fan 90 may be provided at the left side of the moving direction of the printer 1. In this case, a plurality of exhaust openings may be provided or a filter may be provided at the exhaust opening so that the ink mist is locally discharged. Then, the heat generated in the printer 1 during printing can be discharged outside the printer by flowing air in the moving direction by the fan 90 (flowing air in the moving direction by the air sent from the fan) and by providing the exhaust opening for the air from the fan 90, and cooling effect inside the printer 1 can be also obtained. Further, since air is flowed around the head 41 by the fan 90, heat generation of the head 41 caused by ejection of ink can be restrained. As a result, ejection error of ink caused by excessive heat generation of the head 41 can be prevented.

Further in the printer 1 of the embodiment, position detection (position control) of the head 41 is performed based on a linear scale 52 attached at the back surface side (upstream side) of the head 41 along the moving direction. Since the air from the fan 90 is flowed along the moving direction, it becomes difficult that ink mist is adhered on the linear scale 52. As a result, position control of the head 41 can be performed with high dimensional accuracy for a long period.

Further, in the first embodiment, as shown in FIG. 6B, the head 41 is positioned between a position at which air is flowed by the fan 90 in the moving direction and the linear scale 52. That is, the linear scale 52 is positioned at the upstream side of the transport direction with respect to the head 41, and the flow position of the air from the fan 90 is positioned at the downstream side in the transport direction with respect to the head 41, and the air from the fan 90 is flowed in the moving direction at the side opposite the linear scale 52 with respect to the head 41 as a border. Herewith, the air flowed in the moving direction while attracting ink mist and the linear scale 52 can be separated as far as possible, and it can be prevented that the linear scale 52 is tainted.

If the air from the fan is blown toward the upstream side of the transport direction perpendicular to the moving direction, the ink mist floating in the moving range of the head 41 is adhered on the linear scale 52. If the linear scale 52 is tainted, the position control of the head 41 is not precisely performed. Even for a printer having no linear scale, when air from the fan is blown in the transport direction perpendicular to the moving direction, ink mist is adhered on a paper feed member or a paper discharge member, and a medium may be tainted.

That is, when the air from the fan is flowed in the transport direction, ink mist is adhered on a member positioned in the transport pathway of a medium and a medium may be tainted. On the other hand, as the fan 90 of the embodiment, by flowing air from the fan 90 in the moving direction, ink mist can be moved to a position (non print area) at which no medium is tainted.

Note that, in the embodiments the air from the fan 90 positioned at the right side of the moving direction is flowed from the right to the left of the moving direction. Consequently, the fan 90 blows air with ink mist from the print area to the non print area. However, this is not limited, and the fan positioned at the right side of the moving direction may suction the air in the printer 1 to flow the air from the left side to the right side of the moving direction (may generate airstream along the moving direction). However, it is easy to flow air in the moving direction when blowing air from the fan 90 as in the first embodiment than when suctioning air by the fan.

In the first embodiment, as shown in FIG. 6A, the air from the fan 90 flows above the head 41, and as shown in FIG. 6B, the air from the fan 90 flows the downstream side of the head 41. That is, it is avoided that the air from the fan 90 is directly blown to the head 41 or a member around the head 41 while using the moving space of the head 41. That is, the head 41 and a member around the head 41 are not positioned at at least a part the pathway of the air from the fan 90. Herewith, it can be prevented that the air from the fan 90 hits the head 41 or a member around the head 41 to disturb the airstream along the moving direction and to weak the amount of the airstream. Even when air flows at the position deviated from the head 41, the area in which air flows becomes a negative pressure area as described above. Accordingly, the ink mist floating in the moving range of the head 41 can be attracted in the airstream to move the ink mist to the non print area.

In the case where a partition is provided between the pathway of the air from the fan 90 and the fan 90, and an opening (for example: slit) for sending the air from the fan 90 is provided in the partition, an area extending from the opening in the direction in which air is sent becomes the pathway of the air from the fan 90. In the case where the partition is not provided, an area extending in the direction in which air from the fan 90 itself is sent becomes the pathway of the air from the fan 90.

Further, it is not limited that the air from the fan 90 may be deviated above the head 41 and at the downstream side of the transport direction (direction perpendicular to the predetermined direction) of the head 41, and may be deviated below the head 41 and at the upstream side of the transport direction of the head 41. However, as described above, the position of the linear scale 52 and the position of the airstream (pathway of air) can be set apart by flowing the air from the fan 90 to the downstream side of the head 41, and it can be further prevented that ink mist is adhered on the linear scale 52.

Further, it can be prevented that the ink adhered on the platen 24 positioned below the head 41 is flown up by flowing the air from the fan 90 above the head 41. There is a fear that an ink drop ejected from the head 41 is landed at a position deviated from the normal position when air flows between the nozzle surface of the head 41 and the paper S. Accordingly, it is preferable that the air from the fan 90 is flowed above the head 41, that is, at least above the nozzle surface of the head 41 (corresponding to the liquid ejection surface).

Further, as shown in FIGS. 6A and 6B, when the air from the fan 90 is sent from the right side to the left side of the moving direction (predetermined direction), exterior clean air (air not including ink mist or the like) can be flowed in the printer 1 by suctioning air from outside the printer 1. However, air in the printer may be suctioned from the right side of the fan 90 to flow the air from the right side to the left side of the moving direction.

### Second Embodiment: Prevention of Adherence of Ink Mist

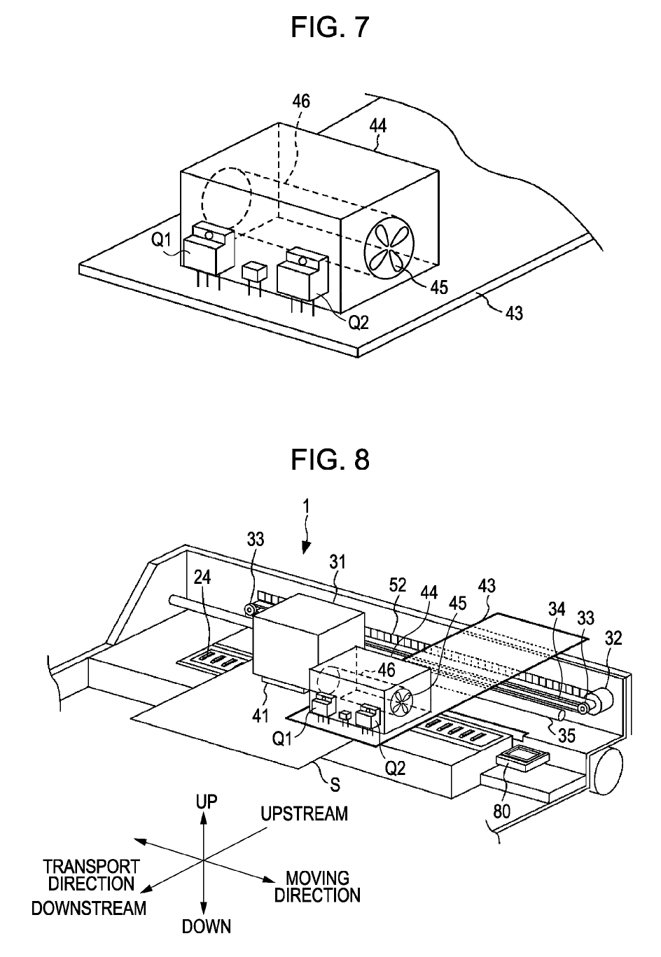

FIG. 7 is a diagram showing a heat sink 44 attached to make contact with the transistors Q1, Q2 on a substrate 43 of the driving signal generating circuit. There is a point called as a bond part (not shown) in a semiconductor constituting the transistor, and the bond part generates heat when the transistor generates the driving signal COM. When the temperature of the transistor itself becomes high with the heat generation, there is a fear that the transistor is destroyed. Consequently, as shown in FIG. 7, the heat sink (radiation member) is provided to make contact with the pair of transistors. The heat sink 44 radiates the heat generated by the transistors Q1, Q2 outside. Consequently, rising of the temperature of the transistors Q1, Q2 can be prevented by the heat sink 44.

Further, a cavity 46 having a cylindrical shape is provided in the heat sink 44 of the embodiment. By providing the cavity 46, the surface area of the heat sink 44 is increased, and the heat amount radiated in the air is increased with the increase of the surface area. Further, a fan 45 is provided at one side among side surfaces of the heat sink 44 that becomes an entrance of the cavity 46. Air is forcibly passed through inside the cavity 46 of the heat sink 44 by the fan 45 to make it easy to transport the heat of the heat sink 44 in the air. As a result, cooling effect of the heat sink 44 and the transistors is increased.

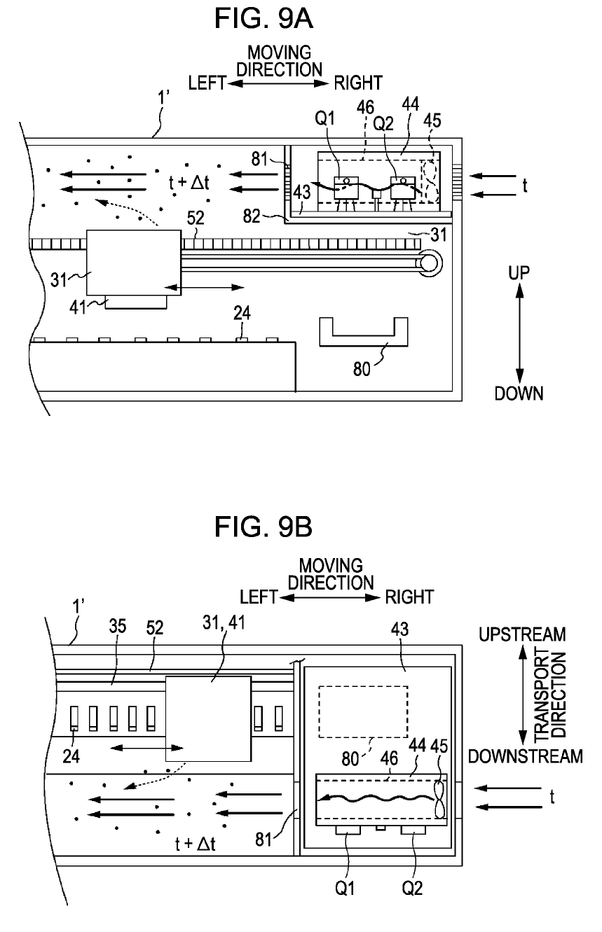

FIG. 8 is a perspective view of a printer 1 according to the second embodiment. FIG. 9A is a cross sectional view schematically showing the printer 1 according to the second embodiment, and FIG. 9B is a top view schematically showing the printer 1 according to the second embodiment. In the second embodiment, the air from the transistor cooling fan 45 shown in FIG. 7 passes through inside the cavity 46 of the sink tank 44, and flows in the printer 1 in the moving direction. As a result, similarly to the fan 90 (FIG. 6) of the first embodiment, the ink mist floating in the moving range of the head 41 can be moved in the non print area. That is, in the second embodiment, the transistor cooling fan is also used as the fan for preventing adherence of ink mist. Herewith, as compared with a printer in which two fans are separately provided, space saving, lowering the cost, simplifying of control, electrical power saving can be provided.

As shown in FIGS. 9A and 9B, the fan 45 of the second embodiment suctions air from the outside of the printer 1 and the air from the fan 45 flows in the printer 1 from the right side to the left side of the moving direction. Consequently, similarly to FIG. 6 of the first embodiment, the ink mist floating in the moving range of the head 41 moves to the non print area by the air blown from the fan 45. As a result, it can be prevented that ink mist is adhered on a periphery member of the head 41 (platen 24 or linear scale 52) to taint a medium.

Incidentally, the substrate 43 on which the heat sink 44 and the transistors Q1, Q2 are attached and the head 41 are surrounded by an outer frame 1′ of the printer 1 as shown in FIGS. 9A and 9B. That is, the heat tank 44, the transistors Q1, Q2, and the head 41 are stored in the same housing (outer frame 1′ of the printer 1). Consequently, when the transistor (driving signal generating unit) generates heat by generating a driving signal, there is a tendency that the heat is retained inside the printer 1 (in the outer frame 1′). Consequently, when using the printer 1, the inner temperature t+Δt of the printer 1 becomes higher than the exterior temperature t of the printer 1. Specifically, the surrounding temperature of the transistors becomes higher than the exterior temperature t.

Therefore, as in the fan 45 of the second embodiment, the temperature of the air passes through inside the cavity 46 of the heat sink 44 becomes low when the air t outside the printer 1 is suctioned inside the printer 1 by the fan 45 than when the air t+Δt inside the printer 1 is discharged outside by the fan 45. That is, the temperature of the heat sink 44 can be lowered when the air outside the printer 1 is suctioned by the fan 45 as compared with the case when discharged, and cooling effect of the transistors is high.

However, when the fan 45 suctions the air outside the printer 1, the air heated by heat generation of the transistors flows in the printer 1 in the moving direction. Consequently, the head 41 positioned in the printer 1 receives influence of the heated air and the temperature is easily increased. When the temperature of the head 41 is excessively increased, ejection error such as dot off, fly bend, and the like may occur or the head itself may be broken.

Consequently, in the second embodiment, as shown in FIGS. 9A and 9B, the substrate 43 on which the heat sink 44, the fan 45, and the transistors Q1, Q2 are provided is disposed above the head 41, and the fan 45 is disposed at the downstream side of the head 41 of the transport direction. Herewith, the air heated by the heat sink 44 flows above the head 41 and at the downstream side of the head 41 in the transport direction in the moving direction. Consequently, it can be prevented that the heated air is directly blown to the head 41.

Further, even when the air from the fan 45 is not directly blown to the head 41, the area in which the air flows becomes a negative pressure area as described above, so that the ink mist floating in the moving range of the head 41 can be attracted in the airstream to move to the non print area. Since the air from the fan 45 does not hit the head 41, it can be also prevented that the airstream along the moving direction is disturbed. Then, by flowing the air from the fan 45 above the head 41, it can be prevented that the ink mist adhered on the platen 24 or the like is flown up or the landing position of an ink drop ejected from the nozzle surface of the head 41 is deviated. Further, by flowing the air at the downstream side of the head 41 in the transport direction, ink mist can be separated from the liner scale 52 positioned at the upstream side of the head 41, and taint caused by ink mist can be further prevented.

That is, increase of the temperature of the head 41 and adherence of ink mist on a peripheral member of the head 41 can be prevented by not directly blowing the heated air from the fan 45 to the head 41.

Further, the ink mist floating in the moving range of the head 41 can be moved to the non print area by flowing the air in the moving direction by suctioning the air in the printer 1 by the fan (even when airstream is generated along the moving direction), or by flowing the air in the moving direction by blowing the air in the printer by the fan 45. However, as in the second embodiment, in the case where the transistor cooling fan is also used as the fan for preventing adherence of ink mist, it is preferable that the fan 45 suctions the air outside the printer 1 and the fan 45 blows the air in the printer 1. As a reason for this, as described above, when the air outside the printer 1 is suctioned by the fan 45, the air outside the printer 1 whose temperature is relatively low can be passed through in the cavity 46 of the heat sink 44 to provide high cooling effect of the transistors.

Further, when the air is flowed in the moving direction by suctioning the air in the printer 1 by the fan (when airstream is generated along the moving direction) the ink mist floating in the moving range of the head 41 is adhered on the substrate 43 on which the fan is provided. When the liquid such as ink mist is adhered on the substrate 43, an electron element on the substrate 43 fails to work to cause failure of the printer 1. Consequently, when the transistor cooling fan is used also as the fan for preventing adherence of ink mist, it can be prevented that ink mist is adhered on the substrate 43 by flowing air in the moving direction by blowing the air outside the printer 1 by the fan 45. On the contrary, when the ink mist comes close to the substrate 43, the ink mist can be kept away from the substrate 43 by blowing of air from the cavity 46 of the heat sink 44.

Note that the fan 45 may be provided at the side surface at the exterior side of the printer 1 among the side surfaces of the heat sink 44 as shown in FIGS. 9A and 9B, or may be provided at the side surface at the inner side of the printer 1 among the side surfaces of the heat sink 44. However, as the surface area of the heat sink 44 becomes larger, the radiation effect becomes high. Accordingly, for example, a wimple may be provided in the cavity 46 of the heat sink 44. When the air outside printer 1 is suctioned in the cavity 46 by the fan 45 as in the second embodiment by using the heat sink 44, it is preferable that fan 45 is disposed at the side surface of the heat sink 44 at the exterior side of the printer 1. Herewith, the amount of the air to be suctioned by the fan 45 becomes large.

Incidentally, ink is ejected from the nozzle selected based on image data in normal printing, whereas a great amount of ink is ejected from many nozzles (every nozzle, or a nozzle having a problem of ejection error) in a flashing operation. Accordingly, a great amount of ink mist is generated also in the flashing.

Consequently, in the second embodiment, the substrate 43 on which the transistors Q1, Q2, the heat sink 44, and the fan 45 are attached is disposed just above the flashing unit 80. The substrate 43 is disposed just above the flashing unit 80 means that the position of the substrate 43 and the position of the flashing unit 80 are the same in the moving direction of the carriage. Herewith, a blowing opening (left side surface of the cavity 46) for the air from the fan 45 attached on the substrate 43 is disposed above the flashing unit 80, and the ink mist generated at the flashing unit 80 is not caught up in the air from the fan 45, and stays in the non print area in which the flashing unit 80 is positioned. As a result, it can be prevented that the ink mist generated at the flashing unit 80 moves to the print area to stain a peripheral member of the head 41.

Further, by disposing the substrate 43 just above the flashing unit 80, a partitioning plate 82 (plate on which the substrate 43 is placed) for placing the substrate 43 is positioned just above the flashing unit 80 as shown in FIGS. 9A and 9B. Consequently, even when ink mist is flown up during flashing, the ink mist is adhered on the lower surface of the partitioning plate 82 and it can be prevented that the ink mist is adhered on the substrate 43.

As shown in FIG. 9A, the partitioning plate 82 placed on the substrate 43 may be a partitioning plate 82 surrounding the substrate 43. The inside of the printer 1 can be separated into “substrate area” in which the substrate 43 is positioned and “head area” in which the head 41 is positioned by the partitioning plate 82. By providing the partitioning plate 82 between the substrate 43 and the head 41, it becomes more difficult that the ink mist floating in the moving range of the head 41 is adhered on the substrate 43. Further, since the radiation heat of the heat sink 44 and the transistors Q1, Q2 can be blocked by the partitioning plate 82, temperature increase of the head 41 can be prevented.

However, it is necessary that the air suctioned from outside the printer 1 is blown in the “head area” by the fan 45 in the “substrate area” surrounded by the partitioning plate 82 in order to move the ink mist floating in the moving range of the head 41 in the “head area” to the non print area at the left side of the moving direction. Accordingly, it is preferable to provide a slit 81 on the partitioning plate 82 opposing the fan 45 as shown in FIGS. 9A and 9B. Herewith, the air from the fan 45 flows in the space in which ink mist is floated over the moving range of the head 41 in the moving direction. Further, the air from the fan 45 is rectified without spreading in the transport direction by the slit 81 provided on the partitioning plate 82, and the air can be more surely flowed in the printer 1 in the moving direction.

### Other Embodiments

Aforementioned each embodiment is described as a print system mainly including an ink jet printer. However, disclosure of a method of reducing adherence of ink mist on a member and the like is included. Further, the aforementioned embodiments are described for easy understanding of the invention, and should not be understood to restrict the invention. It goes without saying that modifications and variations can be made without departing from the gist thereof, and that an equivalent of the embodiments is included in the invention. Specifically, embodiments described below are also included on the invention.

### Fan

As in the embodiments, when air is flowed in the moving direction by the fan, it is not limited that air is blown above the head 41 and at the downstream side of the transport direction, and air may be flowed below the head 41 and at the upstream side of the transport direction, or right beside the head 41 as far as air is flowed around the head 41. Herewith, the ink mist floating around the head 41 (moving range of the head 41) can be moved to the non print area, and taint of a periphery member of the head 41 can be prevented.

Further, in the aforementioned embodiments, air is flowed in the predetermined direction (moving direction) by suctioning air from outside the printer 1 and sending the suctioned air in the printer by the fan. However, air may be flowed in the moving direction by suctioning the air inside the printer by the fan to generate a stream by the suctioned air. However, rectifier effect is high when air is flowed in the moving direction by sending air in the printer from the fan than when the air in the printer is suctioned by the fan. As a result, ink mist can be moved to the non print area without adhering the ink mist on a head periphery member. Liquid Ejecting Apparatus

In the aforementioned embodiments, the ink jet printer is exemplified as the liquid ejecting apparatus However, the liquid ejecting apparatus is not limited to the ink jet printer, and may be various industrial apparatuses. For example, the invention can be applied to a print device that draws a design on a fabric, a display manufacturing device such as a color filter manufacturing device, an organic EL display, or the like, a DNA chip manufacturing device for manufacturing a DNA chip by applying solution in which DNA is melted on a chip, a circuit substrate manufacturing device, or the like.

Further, ejection system of liquid may be a piezo system in which liquid is ejected by applying a voltage to a driving element (piezo element) to expand/contract an ink chamber, or may be a thermal system in which bubbles are generated in a nozzle by using a heat element to eject liquid by the bubbles.

What is claimed is:

1. A liquid ejecting apparatus comprising:
a head for ejecting liquid on a medium;
a moving mechanism for moving the head in a predetermined direction; and
a fan, wherein
the fan flows air in the liquid ejecting apparatus in the predetermined direction.

2. The liquid ejecting apparatus according to claim 1, wherein
a position of the head is detected based on a linear scale attached along the predetermined direction.

3. The liquid ejecting apparatus according to claim 2, wherein
the head is positioned between a position at which air is flowed in the predetermined direction by the fan and the linear scale.

4. The liquid ejecting apparatus according to claim 1, further comprising:
a driving signal generating unit for generating a driving signal, wherein
the head ejects liquid depending on the driving signal, and
the fan is provided for cooling the driving signal generating unit.

5. The liquid ejecting apparatus according to claim 1, wherein
air is sent in the predetermined direction by the air sent from the fan.

6. The liquid ejecting apparatus according to claim 1, wherein
the fan flows air at a position deviated in a direction perpendicular to the predetermined direction with respect to the head.

7. The ejecting apparatus according to claim 1, wherein
the fan flows air above a liquid ejection surface of the head.
